(19) United States
(12) Patent Application Publication
(10) Pub. No.: US 2025/0047633 A1
(43) Pub. Date: Feb. 6, 2025

(54) MULTICAST DELIVERY OF NOTIFICATIONS VIA SERVICE COMMUNICATION PROXY IMPLEMENTING NAME-BASED ROUTING

(71) Applicant: InterDigital Patent Holdings, Inc., Wilmington, DE (US)

(72) Inventor: Sebastian Robitzsch, London (GB)

(73) Assignee: InterDigital Patent Holdings, Inc., Wilmington, DE (US)

(21) Appl. No.: 18/715,045

(22) PCT Filed: Dec. 2, 2022
(86) PCT No.: PCT/US2022/051732

§ 371 Date: May 30, 2024

Related U.S. Application Data
(60) Provisional application No. 63/285,162, filed on Dec. 2, 2021.

(51) Int. Cl. H04L 61/4511; H04W 76/10; H04W 80/06

(52) U.S. Cl. CPC H04L 61/4511; H04W 76/10; H04W 80/06

(57) ABSTRACT

An example device may determine a fully qualified domain name (FQDN) using a service operation, a producer identifier, and a parent domain, wherein the service operation is associated with a network function, and wherein the producer identifier identifies a producer device that provides the service operation; generate a target address using the FQDN and an event name, wherein the event name indicates a network function event: send a request message to the producer device using the target address, wherein the request message indicates a request to subscribe to the service operation for the network function event; receive a confirmation message from the producer device, wherein the confirmation message indicates that the device is subscribed to the service operation for the network function event; and receive an event message from the service operation provided by the producer device, wherein the event message indicates that the network function event has occurred.

### CROSS-REFERENCE TO RELATED APPLICATIONS

This application claims the benefit of U.S. Provisional Patent Application No. 63/285,162, filed Dec. 2, 2021, the contents of which are hereby incorporated by reference herein.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein for multicast delivery of notifications via a Service Communication Proxy (SCP) implementing name-based routing (NbR). Message buses may be able to notify connected endpoints about events in a broadcast/multicast fashion. SCPs (e.g., service routing component for 3GPP 5G Core Network Functions) may not include such a feature. A reason for that may be that 5GC notifications are sent via Hypertext Transfer Protocol (HTTP), which may be a unicast protocol, and standard IP protocol suite(s) may not allow such behavior.

An SCP deployment option (e.g., Deployment Option 3, which may be referred to as Name-based Routing) may be implemented to deliver HTTP-based notifications in a multicast fashion, which may bring message bus features to the routing domain of SCPs. Such an implementation may be achieved through extending the Fully Qualified Domain Name (FQDN)-based IP endpoint registration procedures with a flag (e.g., a new flag) indicating that HTTP POST requests may be delivered in a multicast fashion for a specific FQDN. A NbR may determine at its ingress point (e.g., for each HTTP POST) whether the HTTP POST to a specific FQDN may be sent in a multicast fashion. The FQDN-based IP endpoint registration procedures may be extended with a flag (e.g., a second flag) indicating the suppression of HTTP responses back to the requester, e.g., in the case of a multicast delivery of HTTP POST requests. NbR may determine at its egress point (e.g., for each HTTP response) whether the HTTP response back to the IP endpoint may be (e.g., only) treated as a duplicate by the IP endpoint.

An SCP may become a mandatory component serving WTRUs on a control plane for (e.g., any) signaling with network functions (e.g., 5GC NFs).

Systems, methods, and instrumentalities are described herein for multicast delivery of notifications via a Service Communication Proxy (SCP) implementing name-based routing (NbR). A service operation, producer identifier, and parent domain may be used to determine a first fully qualified domain name (FQDN). The service operation may be associated with a network function. The producer identifier may identify a producer device that provided the service operation. A target address may be generated using the first FQDN and an event name. The event name may indicate a network function event. A request message may be sent to the producer device using the target address. The request message may indicate a request to subscribe to the service operation for the network function event. A confirmation message may be received from the producer device. The confirmation message may indicate that the device was subscribed to the service operation for the network function event. An event message may be received from the service operation provided by the producer device. The event message may indicate that the network function event has occurred.

Systems, methods, and instrumentalities are described herein for multicast delivery of notifications via a Service Communication Proxy (SCP) implementing name-based routing (NbR). A first fully qualified domain name (FQDN) may be determined using a service operation, a producer identifier, and a parent domain. The service operation may be associated with a network function. The producer identifier may identify a producer device that provided the service operation. A request message may be received from a consumer device using a target address. The request message may indicate a request to subscribe to the service operation and the target address associated with the first FQDN. An event name may be determined from the request message using the target address and the first FQDN. The event name may indicate a network function event. A confirmation message may be sent to the consumer device. The confirmation message may indicate that the consumer device may be subscribed to the service operation for the network function event. An event message may be sent to the consumer device when it is determined that the network function event has occurred.

Systems, methods, and instrumentalities are described herein for multicast delivery of notifications via a Service Communication Proxy (SCP) implementing name-based routing (NbR). A first message may be received from a consumer device. The first message may indicate a request to subscribe to a service operation for a network function event. The service operation may be associated with a network function. The request may comprise a target address that may have been generated using a first fully qualified domain name (FQDN). A producer address for a producer device may be determined using the first message, the target address, and/or the first FQDN. A second message may be sent to the producer device using the producer address. The second message may indicate the request. The system then received an event message from the service operation provided by the producer device. The event message may indicate that the network function event has occurred. A consumer address for the consumer device may be determined using the event message. The event message may be sent to the consumer device using the consumer address.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example process of using a reverse proxy to expose a set of microservices implementing a single network function (NF).

FIG. 3 illustrates an example process of using full exposed and addressable microservices implementing a single network function (NF).

FIG. 4 illustrates an example subscribe-notify NF service.

FIG. 5 illustrates an example system architecture of Named-based Routing (NbR).

FIG. 6 illustrates an example procedure for registration of producer and consumer instances.

FIG. 7 illustrates an example procedure for handing subscription to notifications.

FIG. 8 illustrates an example procedure of multicast delivery of HTTP requests comprising notifications to multiple consumers.

### EXAMPLE NETWORKS FOR IMPLEMENTATION OF THE EMBODIMENTS

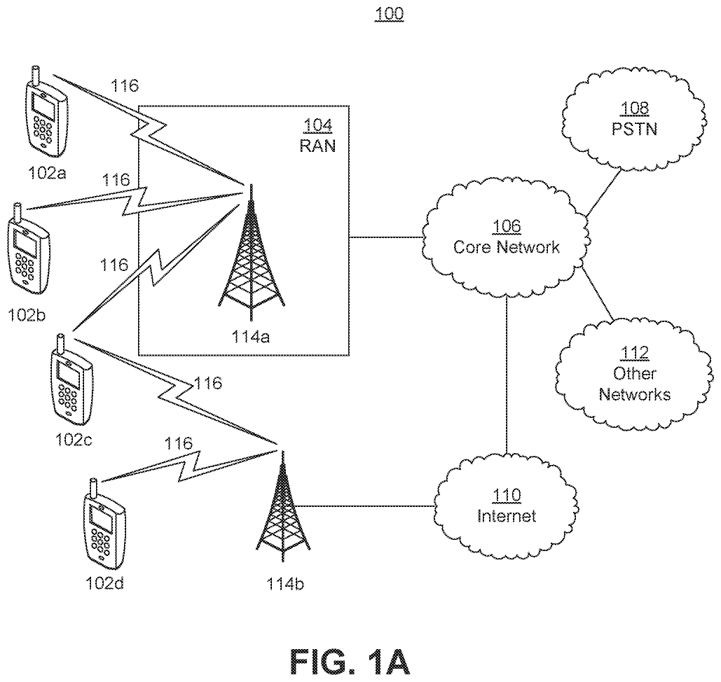

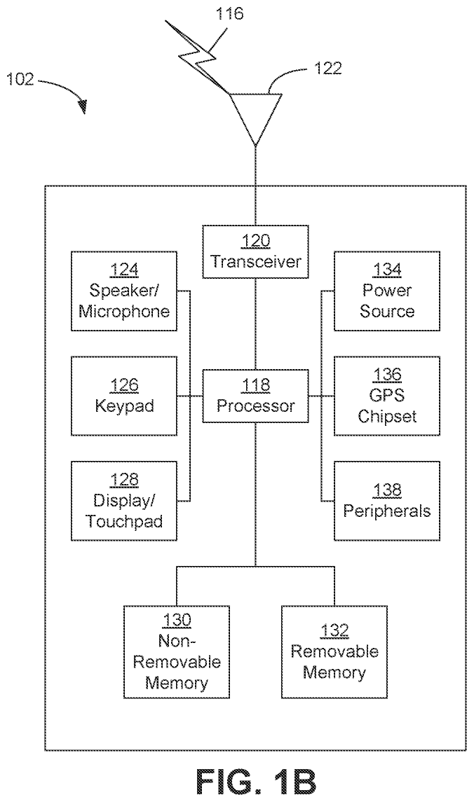

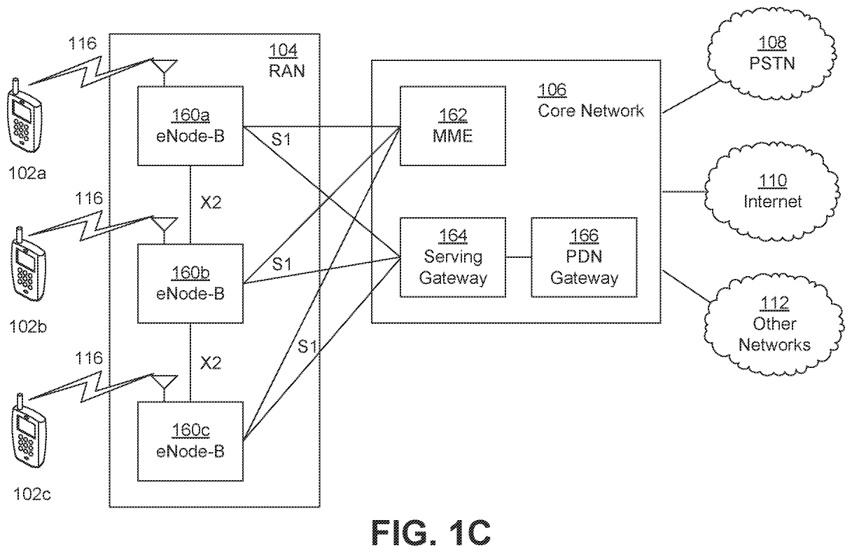

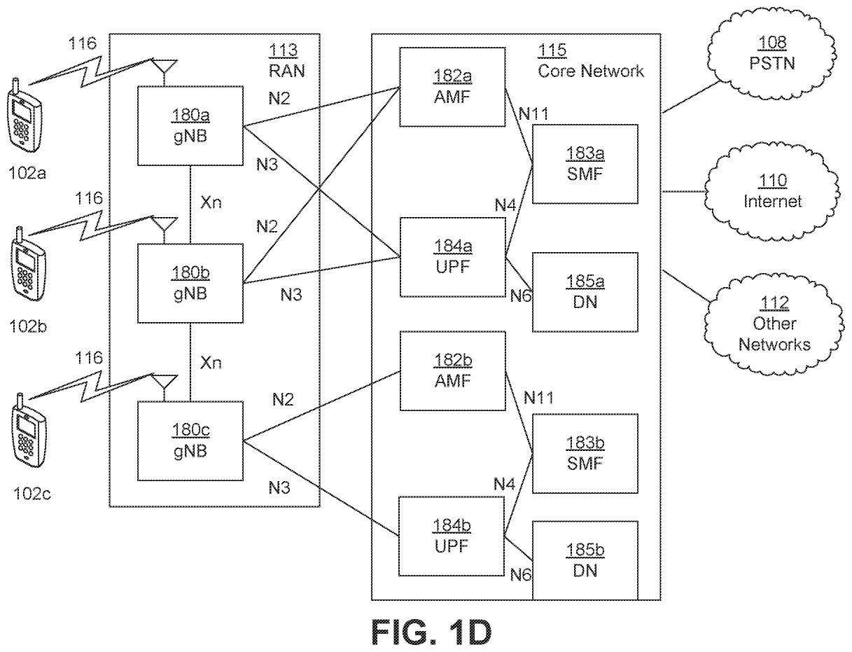

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a ‘station’ and/or a ‘STA’, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 1041113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, alight sensor, a touch sensor, a magnetometer, a barometer, a gesture sensor, a biometric sensor, and/or a humidity sensor.

The WTRU 102 may include a full duplex radio for which transmission and reception of some or all of the signals may be concurrent and/or simultaneous. For example, a frame may be associated with the uplink (UL) for a transmission and the downlink (DL) for a reception. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as machine type communication (MTC) devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing protocol data unit (PDU) sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in alab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Network functions (e.g., 5G Core Network Function) may be implemented as microservices and their addressing may be implemented. A network function may be a network exposure function (NEF), network repository function (NRF), policy control function (PCF), unified data management (UDM), authentication server function (AUSF), access and management mobility function (AMF), session management function (SMF), a combination thereof, and/or the like. Service-based Architecture (SBA) may use Hypertext Transfer Protocol (HTTP) Version 2 (HTTP/2) as the application layer protocol with JavaScript object notation (JSON)-encoded payloads. The SBA may not have the requirement of which control plane network functions are permitted to communicate with each other.

Embodiments described herein may use an internet protocol, also called an internet protocol suite. The internet protocol suite may be a framework for organizing the set of communication protocols used for network communication. The internet protocol suite may provide end-to-end data communication specifying how data may be packetized, addressed, transmitted, routed, and received. This functionality may be organized into abstraction layers such as a link layer, which may contain communication methods for data that remains within a network segment (e.g., a link); an internet layer, which may provide internetworking between independent networks; a transport layer, which may handle host-to-host communication; and an application layer, which may provide process-to-process data exchange for applications. The link layer may include protocols such as Ethernet, Wi-Fi, Point-to-Point Protocol (PPP), and/or the like. The internet layer may include the internet protocol (IP), IPv4, IPv6, the internet control message protocol (ICMP), and/or the like. The transport layer may include Transmission Control Protocol (TCP), User Datagram Protocol (UDP), Datagram Congestion Control Protocol (DCCP), Stream Control Transmission Protocol (SCTP), and/or the like. The application layer, which may use the services of the other layers, may include applications such as HyperText Transfer Protocol (HTTP), HTTP Secure (HTTPS) (e.g., HTTP and/or TLS), File Transfer Protocol (FTP), Simple Mail Transfer Protocol (SMTP), Dynamic Host Configuration Protocol (DHCP) and/or the like.

As disclosed herein, various protocols may be used to establish sessions between two devices. For example, the Transmission Control Protocol (TCP) may be used to establish a connection-oriented communication session over the internet protocol suite. When establishing a TCP session, one device may act as a server, sending and receiving data packets, while the other device may act as a client. When opening the TCP session, both devices may exchange an initial sequence number, which allows each device to keep track of received data packets. UDP may be used similarly.

As disclosed herein, the terms WTRU and device may be used interchangeably. For example, a device may be a WTRU, a server, a consumer device, a producer device, an SCP, and/or the like.

In an example, network (e.g., 5G Core (5GC)) software implementations may utilize a 12-factor app methodology, which may define how microservices may be implemented to allow the scaling of them based on demand (e.g., the economy at scale). This may request and/or require the decomposition of a network function (e.g., a 5GC Network Function (NF)) from an (e.g., monolithic) component into a set of microservices. The decomposition may not be standardized and may be up to each vendor to decide. In an example, an NF may be split into its functional components (e.g., notification handlers).

If an NF has been decomposed, a microservice (e.g., each microservice) may be made available to other microservices to be called. There may be a number of approaches (e.g., two approaches) on how to achieve this.

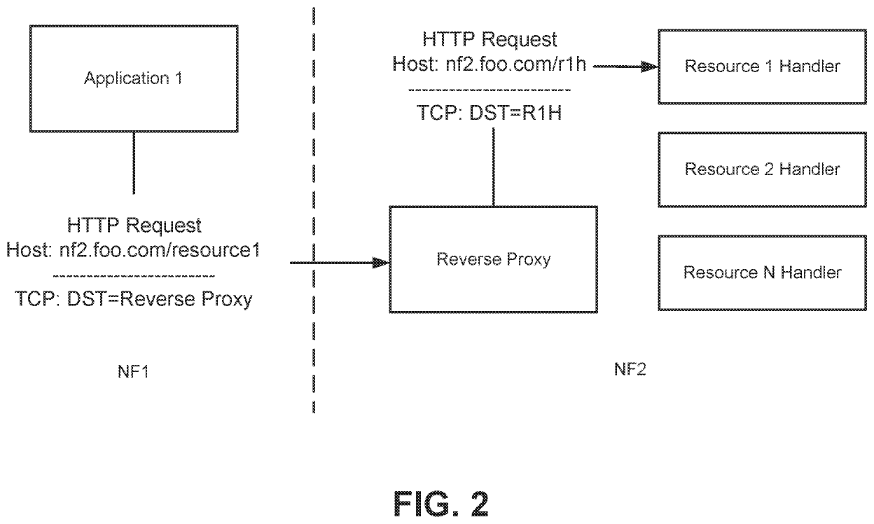

In an example, an approach may use a reverse proxy. An (e.g., entire) NF may be exposed under a single Fully Qualified Domain Name (FQDN) and may point to a reverse proxy. FIG. 2 illustrates an example process of using a reverse proxy to expose a set of microservices implementing a network function (e.g., a single network function). NF2 may be decomposed into a set (e.g., if microservices are depicted as separate handlers). The set may include a microservice for a (e.g., each) resource, e.g., Resource 1, Resource 2, and the like. The reverse proxy may be implemented as a microservice and may proxy incoming requests (e.g., based on the resource in a uniform resource locator (URL) to determine which microservice may be used to handle it). In FIG. 2, two NFs are illustrated, NF1 and NF2. NF1 may issue a request to nf2.foo.com/resource1, with nf2.foo.com being the FQDN and/resource1 being the resource. The reverse proxy may have a configuration to proxy requests to/resource1 to the microservice Resource 1 Handler on a specific IP address. In some examples, the reverse proxy may rewrite the resource in the URL. FIG. 2 depicts the TCP destination IP address for NF1, and the reverse proxy may indicate that the reverse proxy terminates TCP sessions.

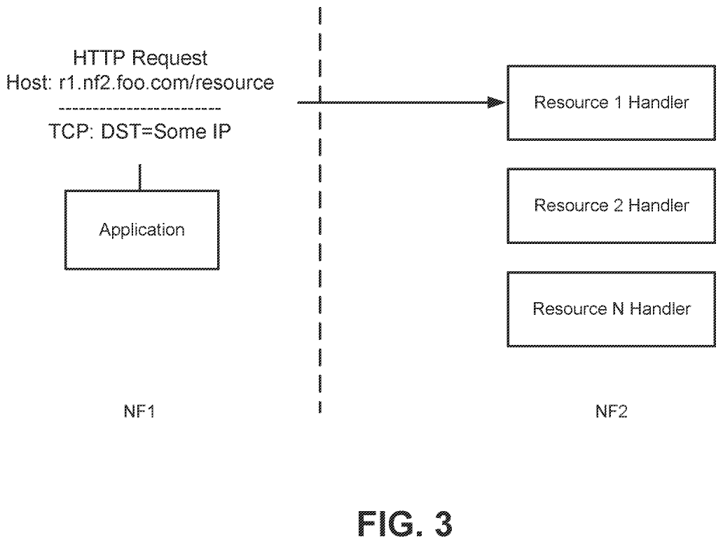

In an example, an approach may use a FQDN. A (e.g., each) type of microservice may be exposed under a system-wide registered FQDN, which may allow an (e.g., any) NF to reach this service endpoint (e.g., in contrast to a dedicated reverse proxy as the ingress point into an NF). FIG. 3 illustrates an example process of using exposed and/or addressable microservices implementing a single network function. NF1 may aim to reach the service endpoint that handles resources of a type, e.g., Resource 2. As a naming convention, a (e.g., each) resource handler of NF2 may use a Partially Qualified Domain Name (PQDN) n2.foo.com with sub-domains r1, r2, and so on. Similar to the reverse proxy in FIG. 2, NF1 may aim to reach the Resource 1 Handler and may issue a request (e.g., directly) to r1.nf2.foo.com/resource.

Routing of inter-network function communication may be implemented.

A Service Communication Proxy (SCP) may take over the routing of packets between Service-based Interface (SBI)-enabled network functions (e.g., 5GC NFs). The SCP may be an optional component and, if in use, it may be referred to as an indirect communication; if the SCP is not in use, it may be referred to as a direct communication. Four communication models are defined with two direct and two indirect ones. Model A may be a direction communication mode. No NRF or SCP may be in use for direct routing. Model B may be a direct communication mode. Discovery of a producer may be via NRF and no SCP may be used for routing. Indirect Communication—Model C may be an indirect communication mode. Discovery of a producer may be via NRF, and SCP may take over the routing. The set (of instances) selection may be delegated to the SCP. Indirect Communication—Model D may be an indirect communication mode. The discovery of a producer may be delegated to SCP, which may use the NRF. The SCP routing may take care of routing packets between the consumer and producer.

Subscription to notifications may be implemented.

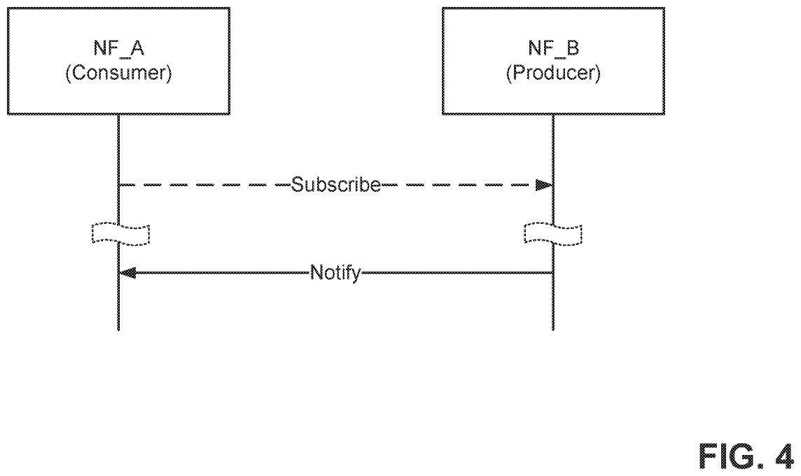

If a NF is configured (e.g., requires) to be informed about (e.g., future) events, consumers (e.g., a subscribing entity) may communicate information in a request (e.g., a request sent to a producer) informing the producer (e.g., a notification provider) where to send the notifications (e.g., related to the future events). This notification endpoint (e.g., a Notification Target Address, also referred to as a target address) may be used by the producer to send (e.g., any) requested notification to a list of consumers that requested it. FIG. 4 illustrates an example subscribe-notify NF service. A number of subscription models may be used. For example, three subscription models may be used to communicate the aforementioned Notification Target Address: an Explicit Subscription, an Implicit Subscription, and/or a Default Notification Endpoint. Explicit and/or Implicit Subscription models may utilize dedicated HTTP transactions. The Default Notification Endpoint mode may utilize an NF registration with a network repository function (NRF) to communicate (e.g., any) subscriptions (e.g., upfront). The notification may utilize a dedicated HTTP transaction to convey the subscribed event(s).

In an embodiment, a target address may be or may include an FQDN, an IP address, a WTRU identifier, a server identifier, an endpoint address, an SCP identifier, a server operation, a server operation identifier, a consumer, a consumer identifier, a producer, a producer identifier, a parent domain, an event name, a combination thereof, or the like.

A number of communication models may be provided. For example, four communication models may be provided for inter-NF communication. In an example, such as in the case of subscriptions, one of the four models may be followed. In response to an event taking place, a notification may be sent (e.g., directly) to the Notification Target Address (e.g., assuming that if an SCP is in place). The SCP may permit the routing towards the Notification Target Address.

Name-based Routing (NbR) may be implemented.

There may be a number of deployment options, such as three deployment options of the SCP: Service Mesh, Independent Service Units, and NbR. The architecture for the NbR-based SCP are described herein.

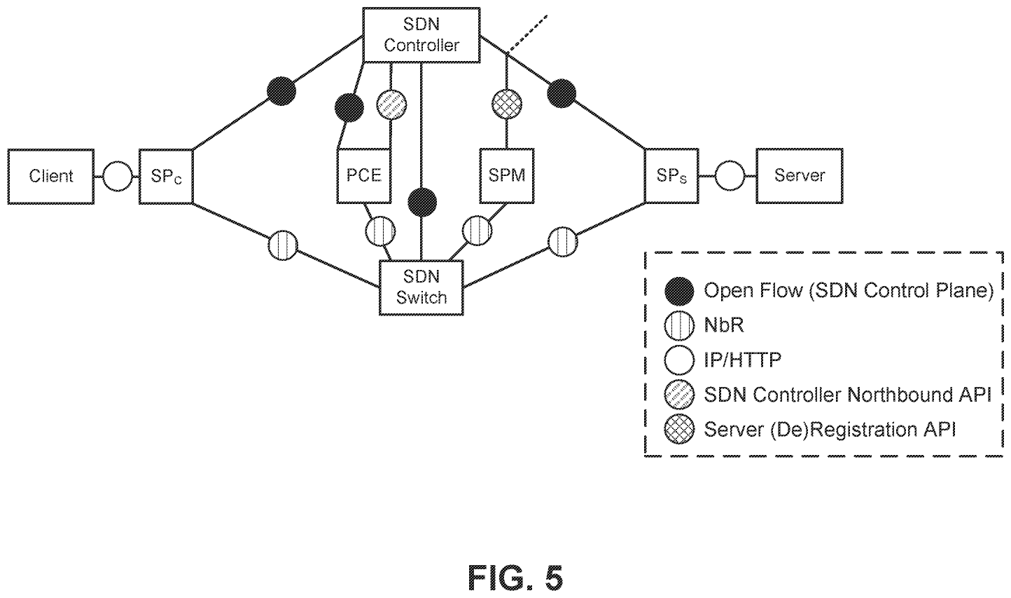

An (e.g., core) objective of NbR may be the ability to offer transparent service routing for HTTP services and preserve the nature of the communication stack of endpoints utilizing the IP suite. NbR (e.g., internally) may utilize information-centric networking (ICN) (e.g., publish/subscribe) concepts for decoupling the information space of who has the information from the underlying routing. NbR may (e.g., seamlessly) integrate with a software defined networking (SDN)-based switching fabric, such as for example, OpenFlow 1.3 and above. NbR may include Service Proxies (SPs) at each side of the client-server communication, and the SPs may translate the IP world into ICN and vice versa. The Path Computation Element (PCE) may perform the matching of publishers to subscribers and may perform the calculation of the path through the network. FIG. 5 illustrates an example system architecture of named-based routing (NbR). The NbR architecture may include NbR components such as, for example, the SP serving the client (SPC), the SP serving the server (SPS), and the PCE. The SDN switching fabric and interfaces are illustrated in FIG. 5. As illustrated, the NbR architecture may provide an interface for registering/deregistering servers against/from the routing layer. This interface may be offered by the Service Proxy Manager (SPM) and may be implemented as a representational state transfer (RESTful) application programming interface (API).

Message brokers in the cloud world (e.g., Message Queuing Telemetry Transport (MQTT) or RabbitMQ) may follow a publish/subscribe model where events may be sent out to subscribers in a broadcast fashion. In the case of 5GC NFs, there may be no mechanism (e.g., foreseen) to offer broadcast delivery of events, e.g., due to the unicast semantic of HTTP between two endpoints. If an NF issues a number of notifications with other NFs having subscribed for them, there may be a severe networking and/or processing load, which may be on a routing layer, to deliver notifications in a unicast fashion.

SCP deployment option NbR may allow the delivery of HTTP responses (e.g., in a multicast fashion) to HTTP clients that await a response to the same URL (e.g., based on HTTP GET requests). NbR may not support the delivery of HTTP requests (e.g., to ease the load on a networking layer). If NbR has built-in support for the multicast delivery of HTTP requests, there may not be a standardized method on naming conventions to achieve the built-support, e.g., because NbR is (e.g., inherently) built upon the routing of packets to endpoints based on names, such as IP addresses or FQDNs. Standards may need to impose a naming convention so that (e.g., in particular, multi-vendor) deployments may utilize the (e.g., unique) routing capabilities of NbR.

Delivering notifications among SBI-enabled network functions (e.g., 5GC NFs) in a multicast fashion (e.g., over the SCP implementing NbR) may be implemented. A naming convention for SBI-enabled NFs on how FQDN may be constructed for NbR (e.g., to offer the ability to deliver notations in a multicast fashion) may be implemented.

Decomposition of consumer(s) and/or producer(s) may be implemented.

Network functions (e.g., 5GC NFs) may be implemented as microservices and may allow implementation of notification handlers as dedicated microservices, e.g., with the introduction of service-based architecture (SBA). Such implementation may allow a (e.g., more) scalable NF consumer, which may not get affected by incoming notifications, e.g., in terms of packet load or malfunctioning of the notification handler (e.g., which (e.g., ultimately) may cause the (e.g., entire) NF to fail). Such implementation may enable dedicated notification handlers implemented as individual microservices for specific service operations, e.g., based on their complexity or due to business-related requirements (e.g., multi-vendor implementation of a single NF).

Registration of consumer and producer notification handlers may be implemented.

A device (e.g., a consumer) may determine a first fully qualified domain name (FQDN) using a service operation, a producer identifier, and a parent domain. For example, the following naming convention for the first FQDN (and/or other FQDNs) may be used:
<SERVICE_OPERATION>.<PRODUCER>.<PARENT_DOMAIN>

<SERVICE_OPERATION> may be one of the offered service operations listed by a (e.g., each) 5GC NF. In the case of notifications, the service operation name provided in the NF's table may become a standardized sub-domain in an FQDN, which may follow naming convention(s), such as allowed characters, case insensitive, etc. <PRODUCER> may be a producer identifier that identifies a producer device that provides the service operation. For example, if the service operation is a notification, the producer device may be the NF that issues the notification (e.g., an AMF), or the NF may be a control plane function (CPF) and/or a direct discovery name management function (DDNMF). <PARENT_DOMAIN> may be a Partially Qualified Domain Name (PQDN) representing a vendor or deployment (under which NFs may have been registered), e.g., foo.com. The <SERVICE_OPERATION> may be an offered service operation. The service operation may be associated with an NF. For example, the service operation may include a notification service and/or a subscription service.

The service operation may be a context transfer (e.g., UEContextTransfer), a request to create a subscription (e.g., CreateSubscription), a request to enable reachability for a WTRU (e.g., EnableUEReachability), a request to provide positioning information (e.g., ProvidePositioninglnfo), a combination thereof, and/or the like. The service operation may be a 3GPP service operation and/or an operation associated with a network function, which may be a 3GPP network function.

The producer may generate a Notification Target Address (sometimes referred to as a target address) using the first FQDN and an event name. The Notification Target Address may be, for example, a URL. The event name may indicate an NF event. To allow the delivery of notifications in a multicast fashion over an NbR-based SCP, the following naming convention for the Notification Target Address may be used:
<SERVICE_OPERATION>.<PRODUCER>.<PARENT_DOMAIN>/Subscribe/<EVENT_NAME>.

In an embodiment a target address may be or may include an FQDN, an IP address, a WTRU identifier, a server identifier, an endpoint address, an SCP identifier, a server operation, a server operation identifier, a consumer, a consumer identifier, a producer, a producer identifier, a parent domain, an event name, a combination thereof, or the like.

The consumer device may send a request message (e.g., a subscription request message) using the Notification Target Address. The request message may indicate a request to subscribe to the service operation for the NF event. A (e.g., any) notification issued by a producer NF may be based on a (e.g., previous and/or explicit) subscription request by a consumer. This subscription request may comprise the Notification Target Address, to which the producer may send the notification.

In the case of notifications to be sent to the Notification Target Address, the NbR-based SCP may use (e.g., may require) registration of the consumer notification handler's FQDN so the SCP may know which IP endpoint is serving which FQDN. The NbR-based SCP may not restrict the usage of the registration interface (e.g., per se). Whether this registration is conducted (e.g., through an orchestrator) at the provisioning time (e.g., when a 5GC is deployed) or at run time by the consumer may be specific to a (e.g., each) deployment.

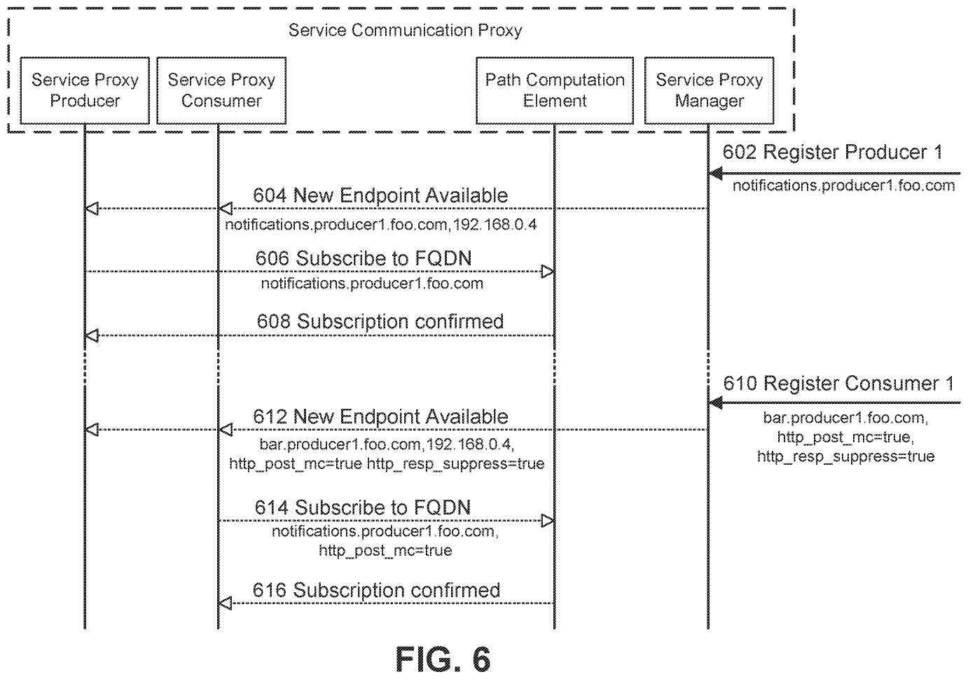

FIG. 6 illustrates an example procedure for the registration of producer and consumer instances. The procedure is illustrated as a message sequence chart for registering notification handlers. As illustrated, a (e.g., new) flag for the FQDN registration procedures to communicate to the SCP that HTTP POST requests to this FQDN may be sent out, e.g., in a multicast fashion. One or more of the following may be performed.

At 602, the SCP may receive an FQDN registration request (e.g., following naming convention procedures described herein). The registration request may be associated with a producer NF offering notifications. The notification handler (e.g., implemented as a microservice) may be registered under an FQDN (e.g., notifications.producer1.foo.com).

At 604, the SPM, which may be part of the NbR-based SCP, may distribute the (e.g., newly) registered IP endpoint to one or more (e.g., all) SPs.

At 606, the SP serving the producer (e.g., SP_{P}, labeled ‘Service Proxy Producer’ in FIG. 6) may subscribe to the FQDN (e.g., following subscription procedures described herein).

At 608, the PCE may update its internal FQDN subscription state for SP_{P}. The PCE may confirm the successful subscription back to SP_{P}.

At 610, registration of a consumer (e.g., Consumer 1) to the Notification Target Address (e.g., bar.producer1.foo.com, as shown in FIG. 6) may be made (e.g., as part of the provisioning of a core network (e.g., an entire 5GC) or by the consumer). The registration may be made using suitable procedures, which may include a (e.g., new) flag (e.g., http_post_mc=true). The flag may indicate that HTTP POST requests to this FQDN may be delivered in a multicast fashion. The registration may include an optional flag (e.g., http_resp_suppress), which may indicate to suppress (e.g., any) HTTP responses to HTTP POST requests sent out in a multicast fashion.

At 612, the SPM may share the registration information with (e.g., all) SPs. The SP serving the consumer (e.g., SP_{C}, labeled “Service Proxy Consumer” in FIG. 6) may learn that it services an (e.g., new) endpoint under the FQDN provided in the registration. The SP_{C}, SP_{P}, and/or other SPs (e.g., all SPs) may read the enabled http_post_mc flag (e.g., for the given FQDN) and/or the http_resp_suppress flag.

At 614, SP_{C} may subscribe to the FQDN, e.g., using suitable procedures. The SP_{C} may add the (e.g., new) flag http_post_mc=true to the request towards the PCE.

At 616, the PCE may update its internal FQDN subscription, which may include the (e.g., communicated) http_post_mc flag state for SP_{C} and may confirm the subscription (e.g., send a confirmation back to SP_{C}).

Consumer subscription to producer notifications may be implemented.

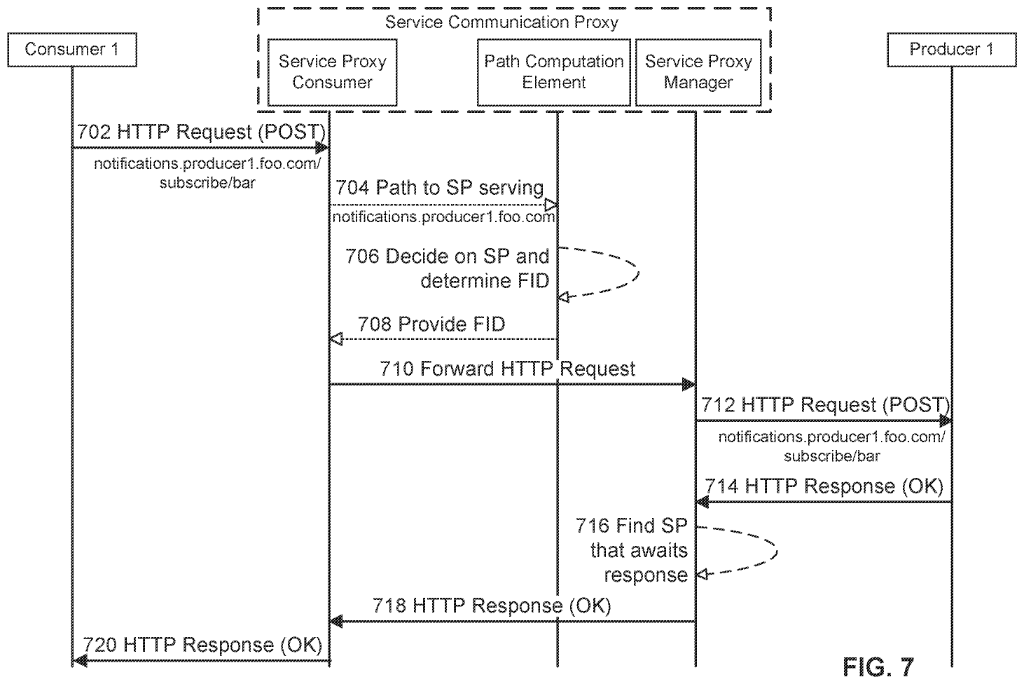

Handling of consumer subscriptions to notifications from producers may be implemented. An NbR-based SCP may be implemented to handle such subscriptions. FIG. 7 is a message sequence chart illustrating an example procedure for handling subscriptions to notifications. In FIG. 7, a consumer (e.g., one consumer, Consumer 1 (C₁)) and a producer (e.g., one producer, Producer 1 (P₁)) are illustrated. The illustrated SCP depicts two SPs, where one SP (e.g., SP_{C}, labeled “Service Proxy Consumer” in FIG. 7) faces (e.g., serves) Consumer 1 and the other SP (e.g., SP_{P}, labeled “Service Proxy Producer” in FIG. 7) faces (e.g., serves) Producer 1. One or more of the following may be performed.

At 702, Consumer 1 may issue (e.g., send) a request message (e.g., an HTTP request) towards Producer 1 (e.g., to subscribe to a notification). Consumer 1 may determine a first FQDN (e.g., notifications.producer1.foo.com) using a service operation, a producer identifier, and a parent domain, as described herein. Consumer 1 may have the (e.g., implicit) knowledge that the FQDN to reach Producer 1 is notifications.producer1.foo.com. Consumer 1 may generate a target address using the first FQDN and an event name that indicates an NF event (e.g., notifications.producer1.foo.com/subscribe/bar, where “bar” is the event name). The request message may indicate a request to subscribe to the event name and/or the service operation (e.g., notifications) for the NF event (e.g., “bar” indicates NF event). The web resource used may be/subscribe/bar; for example, bar may represent a service operator, as described herein.

At 704, SP_{C} may issue a request to the PCE. The request may ask for a Forwarding Identifier (FID) for the SP serving the FQDN notifications.producer1.foo.com (e.g., the FID may identify a path to the SP serving the producer associated with notifications.producer1.foo.com).

At 706, the PCE may find (e.g., identify) a subscriber (e.g., one subscriber) to the FQDN notifications.producer1.foo.com (e.g., a producer subscribed to the FQDN). The PCE may identify the subscriber based on the registration of the FQDN notifications.producer1.foo.com (e.g., as described with respect to 602 in FIG. 6) using SP_{P}. The PCE may determine that SP_{P} is associated with Producer 1 and determine the FID associated with SP_{P}.

At 708, the PCE may send (e.g., provide) the FID to SP_{C} (e.g., back to SP_{C}).

At 710, SP_{C} may send (e.g., forward) the HTTP request to SP_{P} (e.g., using the FID provided by the PCE).

At 712, SP_{P} may determine a producer address for Producer 1 using the HTTP request, the target address, and the first FQDN. SP_{P} may send (e.g., forward) the HTTP request to Producer 1 (e.g., Producer 1 may receive HTTP request from Consumer 1). Producer 1 may determine the first FQDN (e.g., using the naming convention procedures described herein). Producer 1 may determine an event name from the request using the target address and the first FQDN. The event name may indicate an NF event.

At 714, Producer 1 may respond with a confirmation message (e.g., an HTTP response), which Producer 1 may send (e.g., send back) towards SP_{P} (e.g., for SP_{P} to forward to SP_{C} and/or Consumer 1).

At 716, SP_{P} may use the FID (e.g., the same FID used by SP_{C}) to find the SP awaiting the HTTP response (e.g., SP_{C}).

At 718, SP_{P} may send the HTTP response to SP_{C}.

At 720, SP_{C} may send (e.g., forward) the HTTP response to Consumer 1. Consumer 1 may receive the HTTP response (e.g., confirmation message) indicating that Consumer 1 is subscribed to the service operation for the NF event (e.g., is subscribed to notifications for certain NF event(s)).

Although not illustrated in FIG. 7, Producer 1 may determine that the NF event has occurred. Producer 1 may send (e.g., subsequently send) an event message (e.g., in response to determining that the NF event has occurred). Producer 1 may send the event message to SP_{P} (e.g., for SP_{P} to forward the message). SP_{P} may determine a consumer address for Consumer 1 (e.g., using the event message and a second FQDN). The second FQDN may include (e.g., be formed using) the NF event, the producer identifier, and the parent domain (e.g., using the naming convention procedures described herein). SP_{P} may send the event message to Consumer 1 (e.g., using the consumer address).

Consumer 1 may receive the event message from the service operation provided by Producer 1. The event message may indicate that the NF event has occurred. The event message may include at least one of a consumer identification (e.g., a consumer identifier), a producer identification (e.g., producer identifier), a WTRU identification (e.g., WTRU identifier), or a server identification (e.g., server identifier). A WTRU identifier may be used to identify the WTRU or its associated subscriber in various network applications. A WTRU identifier may be an International Mobile Subscriber Identity (IMSI), a Subscription Permanent Identifier (SUPI), a Subscription Concealed Identifier (SUCI), or the like. The event message may be received using the second FQDN. Consumer 1 may determine event message information from the event message (e.g., by decoding the second FQDN). The event message information may include the NF event, the producer identifier, and the parent domain.

Multicast delivery of notifications may be implemented.

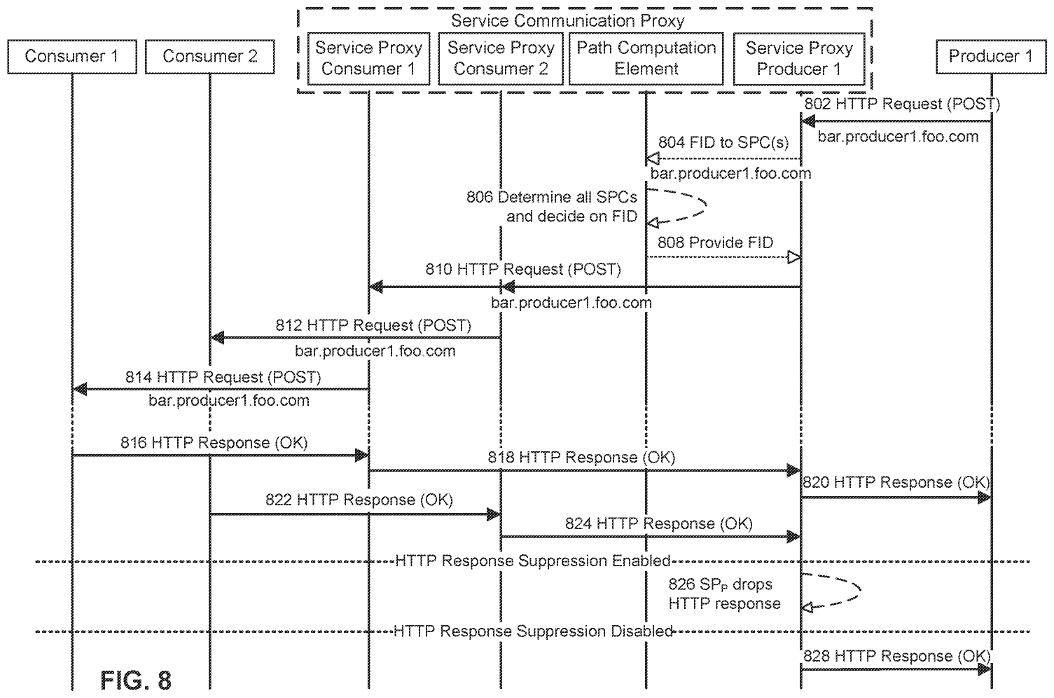

FIG. 8 illustrates an example procedure of multicast delivery of HTTP requests comprising notifications to multiple consumers. The example procedure may be for delivering the notification to (e.g., all) consumers in a multicast fashion over Name-based Routing with one producer, Producer 1 (P1), and two exemplary consumers, Consumer 1 (C1) and Consumer 2 (C2). One or more of the following may be performed.

At 802, Producer 1 may have a (e.g., new) notification for a specific service operator ready to be sent out and may look up a Notification Target Address, which may be communicated by the consumers when subscribing to events. Consumer 1 and Consumer 2 may have provided the same Notification Target Address (e.g., bar.producer1.foo.com), and Producer 1 may issue one HTTP POST request. As two different consumers have subscribed to the same service operation “bar,” the producer may (e.g., only) send one notification event out.

At 804, the service proxy serving the producer (e.g., SP_{P1}, labeled “Service Proxy Producer 1” in FIG. 8) may request the FID from the PCE (e.g., following suitable methods).

At 806, the PCE may find the FQDN bar.producer1.foo.com in its subscriber lists. The subscriber lists may include Service Proxy Consumer 1 (e.g., SP_{C1}) and Service Proxy Consumer 2 (e.g., SP_{C2}). The PCE may see that for this FQDN as a multicast flag http_mc may have been set to true when registering the FQDN. The PCE may generate an FID, which may represent a multicast path towards SP_{C1} and SP_{C2} and back to SP_{P1}.

At 808, the PCE may send the (e.g., calculated) FID back to SP_{P1}.

At 810, using the FID, SP_{P1} may issue a (e.g., single) packet, which may include an HTTP POST request. This packet may arrive at SP_{C1} and SP_{C2} in a multicast fashion.

At 812, SP_{C1} may send the HTTP POST request to Consumer 1, e.g., using a standard IP suite.

At 814, SP_{C2} may send the HTTP POST request to Consumer 2, e.g., using the standard IP suite.

At 816, Consumer 1 may respond to the HTTP POST request, e.g., with an HTTP OK response.

At 818, assuming SP_{C1} (e.g., already) has the FID towards SP_{P1}, SP_{C1} may send the HTTP response to SP_{P1}.

At 820, SP_{P1} may send the HTTP OK response back to Producer 1, e.g., using the standard IP protocol suite.

At 822, Consumer 1 may respond to the HTTP POST request, e.g., with an HTTP OK response.

At 824, assuming SP_{C2} (e.g., already) has the FID towards SP_{P1}, SP_{C2} may send the HTTP response to SP_{P1}.

At 826, assuming SP_{P1} was configured to suppress HTTP responses to POST requests for a specific FQDN (e.g., bar.producer1.foo.com), the HTTP OK response from Consumer 2 may not be sent to Producer 1, e.g., because a previous response had been (e.g., already) sent.

At 828, assuming SP_{P1} was not configured to suppress HTTP responses to POST requests for a specific FQDN (e.g., bar.producer1.foo.com), the HTTP OK response from Consumer 2 may be sent to Producer 1.

Communication (e.g., all communication) between consumer(s) and producer(s) may be based on standardized authentication and/or authorization procedure(s). Independently from the scheme used to authenticate consumer and producer instances to each other for (e.g., each) HTTP transaction, password-based schemes and/or token-based schemes may not be affected by the (e.g., newly introduced) multicast delivery of HTTP requests (e.g., that are described herein). For example, modern implementations utilize JSON Web Tokens (JWTs). JWTs may be based on a time-limited token generated based on username and password that is added to the HTTP request header field Authorization. Based on a shared secret string, JWTs may be deciphered into (e.g., any) given authentication information, e.g., username and password, and may not have to be unique to a specific instance or NF.

SCP or (e.g., any) other routing components may be provided. A routing component may determine where packets may be monitored at ingress and/or egress point. Two HTTP servers may be attached to this routing layer with one HTTP client. The two HTTP servers may be registered under a same FQDN, e.g., foo.com, against the routing layer, e.g., using a suitable method with an extension of registration of consumer and producer notification handlers as described herein or a standard domain name system (DNS) instance with two IP addresses for the same FQDN. When issuing an HTTP POST request to the registered FQDN, e.g., foo.com, both HTTP servers may receive the HTTP POST request.

Systems, methods, and instrumentalities are described herein for multicast delivery of notifications via a Service Communication Proxy (SCP) implementing name-based routing (NbR).

A service operation, producer identifier, and parent domain may be used to determine a first fully qualified domain name (FQDN). The service operation may be associated with a network function. The producer identifier may identify a producer device that provided the service operation. A target address may be generated using the first FQDN and an event name. The event name may indicate a network function event. A request message may be sent to the producer device using the target address. The request message may indicate a request to subscribe to the service operation for the network function event. A confirmation message may be received from the producer device. The confirmation message may indicate that the device was subscribed to the service operation for the network function event. An event message may be received from the service operation provided by the producer device. The event message may indicate that the network function event had occurred.

In an example, a transport session may be established with the producer device. The request message may be sent to the producer device using the target address and the transport session.

The transport session may allow control over session flow, packet sequencing and packet loss (TCP) or packet sequency only (UDP). In an example, the transport session may include a transport layer protocol such as QUIC (e.g., Quick UDP Internet Connection), which may run over UDP but underneath HTTP.

In an example, the confirmation message may be received from the producer device using the transport session.

In an example, the transport session may be at least one of a transmission control protocol (TCP), or a user data protocol (UDP). The transport session may be a transport protocol that may be associated with HTTP.

In an example, the transport session may be a first transport session. A second transport session may be established with the producer device. The event message may be received from the service operation provided by the producer device using the second transport session.

In an example, the event message may be received using a second FQDN. The second FQDN may comprise the network function event, the producer identifier, and/or the parent domain.

In an example, event information may be determined by decoding the second FQDN. The event information may comprise the network function event, the producer identifier, and/or the parent domain.

In an example, the target address may be a uniform resource locator (URL).

In an example, the network function may be at least one of an access and mobility management function (AMF), a control plane function (CPF), or a direct discovery name management function (DDNMF).

In an example, the service operation may be a notification service or a subscription service.

In an example, the event message may further comprise at least one of a consumer identification, the producer identifier, a WTRU identification, a server identification, an access token, a JavaScript object notation (JSON) web token, or notification information.

Systems, methods, and instrumentalities are described herein for multicast delivery of notifications via a Service Communication Proxy (SCP) implementing name-based routing (NbR). A first fully qualified domain name (FQDN) may be determined using a service operation, a producer identifier, and a parent domain. The service operation may be associated with a network function. The producer identifier may identify a producer device that provided the service operation. A request message may be received from a consumer device using a target address. The request message may indicate a request to subscribe to the service operation and the target address associated with the first FQDN. An event name may be determined from the request message using the target address and the first FQDN. The event name may indicate a network function event. A confirmation message may be sent to the consumer device. The confirmation message may indicate that the consumer device may be subscribed to the service operation for the network function event. An event message may be sent to the consumer device when it is determined that the network function event has occurred.

In an example, the event message may be sent to the consumer device using a second FQDN. The second FQDN may comprise the network function event, a producer identification, and/or the parent domain.

In an example, a transport session may be established with the consumer device. The request message may be received from the consumer device using the target address and the transport session.

Systems, methods, and instrumentalities are described herein for multicast delivery of notifications via a Service Communication Proxy (SCP) implementing name-based routing (NbR). A first message may be received from a consumer device. The first message may indicate a request to subscribe to a service operation for a network function event. The service operation may be associated with a network function. The request may comprise a target address that may have been generated using a first fully qualified domain name (FQDN). A producer address for a producer device may be determined using the first message, the target address, and/or the first FQDN. A second message may be sent to the producer device using the producer address. The second message may indicate the request. The system then received an event message from the service operation provided by the producer device. The event message may indicate that the network function event has occurred. A consumer address for the consumer device may be determined using the event message. The event message may be sent to the consumer device using the consumer address.

In an example, a confirmation message may be received from the producer device. The confirmation message may indicate that the consumer device is subscribed to the service operation for the network function event.

In an example, the confirmation message may be sent to the consumer device.ip

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-20. (canceled)

21. A device, the device comprising:
a processor configured to:
generate a fully qualified domain name (FQDN) using a service operation, a producer identifier, and a parent domain, wherein the service operation is associated with a network function, and wherein the producer identifier identifies a producer device that provides the service operation;
generate a target address using the FQDN and an event name, wherein the event name indicates a network function event;
send a request message to the producer device using the target address, wherein the request message indicates a request to subscribe to the service operation for the network function event;
receive a confirmation message from the producer device, wherein the confirmation message indicates that the device is subscribed to the service operation for the network function event; and
receive an event message from the service operation provided by the producer device, wherein the event message indicates that the network function event has occurred.

22. The device of claim 21, wherein the processor is further configured to establish a transport session with the producer device, and wherein the request message is sent to the producer device using the target address and the transport session.

23. The device of claim 22, wherein the confirmation message received from the producer device is received using the transport session.

24. The device of claim 22, wherein the transport session is at least one of a transmission control protocol (TCP), a user datagram protocol (UDP), or a transport protocol associated with a Hypertext Transfer Protocol (HTTP).

25. The device of claim 22, wherein the transport session is a first transport session, wherein the processor is further configured to establish a second transport session with the producer device, and wherein the event message is received from the service operation provided by the producer device using the second transport session.

26. The device of claim 21, wherein the FQDN is a first FQDN, and wherein the event message is received using a second FQDN, and wherein the second FQDN comprises the network function event, the producer identifier, and the parent domain.

27. The device of claim 21, wherein the FQDN is a first FQDN, and wherein the event message is received using a second FQDN, wherein the processor is further configured to determine event information by decoding the second FQDN, and wherein the event information comprises the network function event, the producer identifier, and the parent domain.

28. The device of claim 21, wherein the target address is a uniform resource locator (URL).

29. The device of claim 21, wherein the network function is a control plane function (CPF).

30. The device of claim 21, wherein the service operation is at least one of a notification service or a subscription service.

31. The device of claim 21, wherein the event message further comprises at least one of a consumer identification, the producer identifier, a wireless transmit/receive unit (WTRU) identification, a server identification, an access token, a JavaScript object notation (JSON) web token, or notification information.

32. A method performed by a device, the method comprising:
generating a fully qualified domain name (FQDN) using a service operation, a producer identifier, and a parent domain, wherein the service operation is associated with a network function, and wherein the producer identifier identifies a producer device that provides the service operation;
generating a target address using the FQDN and an event name, wherein the event name indicates a network function event;
sending a request message to the producer device using the target address, wherein the request message indicates a request to subscribe to the service operation for the network function event;
receiving a confirmation message from the producer device, wherein the confirmation message indicates that the device is subscribed to the service operation for the network function event; and
receiving an event message from the service operation provided by the producer device, wherein the event message indicates that the network function event has occurred.

33. The method of claim 32, wherein the method further comprises establishing a transport session with the producer device, and wherein the request message is sent to the producer device using the target address and the transport session.

34. The method of claim 33, wherein the confirmation message received from the producer device is received using the transport session.

35. The method of claim 33, wherein the transport session is at least one of a transmission control protocol (TCP), a user datagram protocol (UDP), or a transport protocol associated with a Hypertext Transfer Protocol (HTTP).

36. The method of claim 33, wherein the transport session is a first transport session, wherein the method further comprises establishing a second transport session with the producer device, and wherein the event message is received from the service operation provided by the producer device using the second transport session.

37. The method of claim 32, wherein the FQDN is a first FQDN, and wherein the event message is received using a second FQDN, and wherein the second FQDN comprises the network function event, the producer identifier, and the parent domain.

38. The method of claim 32, wherein the FQDN is a first FQDN, and wherein the event message is received using a second FQDN, wherein the method further comprises determining event information by decoding the second FQDN, and wherein the event information comprises the network function event, the producer identifier, and the parent domain.

39. The method of claim 32, wherein the target address is a uniform resource locator (URL).

40. The device of claim 32, wherein the network function is a control plane function (CPF).
